(19) United States
(12) Patent Application Publication
(10) Pub. No.: US 2012/0043735 A1
(43) Pub. Date: Feb. 23, 2012

(54) Linkage System and Apparatus for Vehicles

(76) Inventors: Andreas Grauer, Meerbusch (DE); Jörg-Heiner Kroll, Kaarst (DE)

(21) Appl. No.: 13/181,266

(22) Filed: Jul. 12, 2011

(30) Foreign Application Priority Data
Jul. 13, 2010 (DE) 202010008058

(51) Int. Cl. B60G 3/06

(52) U.S. Cl. 280/124.134

(57) ABSTRACT

A linkage apparatus between a wheel suspension, mounted on the chassis of a motor vehicle accommodating the deflection or rebound of a motor vehicle wheel, and a rotation angle sensor connected to a control unit, having a connection rod with first and second ends, a first shaft capable of swiveling mounted on an end of the connection rod and connectable to the wheel suspension, a second shaft capable of swiveling mounted on an end of the connection rod and connectable to the rotation angle sensor, and at least one rotationally symmetrical body of elastically deformable material supporting at least one of the shafts, wherein the connecting rod is bent on at least one of its ends toward an essentially circular grommet that has been forced onto the at least one rotationally symmetrical body of elastically deformable material supporting at least one of the shafts.

### PRIORITY CLAIM

This application claims the benefit of German Patent Application Serial No. 20 2010 008 058 filed on Jul. 13, 2010, contents of which are incorporated herein.

### FIELD OF THE INVENTION

The invention relates to a linkage system and apparatus for vehicles and, more specifically, to linkage between a wheel suspension, mounted on the chassis of a motor vehicle accommodating the deflection or rebound of a motor vehicle wheel, and a rotation angle sensor connected to a control unit.

### BACKGROUND OF THE INVENTION

In a known linkage of this type, a bent connecting rod, for example, is rigidly attached to both sides of ball socket casing, into each of which shaft-bearing balls are inserted.

A vehicle level sensor described in DE 43 09 226 A1 comprises two components arranged movably toward each other and connected with each other, of which the one component is connected with the vehicle chassis and the other component is connected with the wheel suspension. A measuring device in the form of a magnetoresistive sensor is arranged between the components. The components are connected with each other by a ball joint consisting of a ball inserted in a ball socket, whereby the magnetoresistive sensor is arranged in the area of the ball socket.

### SUMMARY OF THE INVENTION

The present invention is directed to an improved and simplified linkage between a wheel suspension, mounted on the chassis of a motor vehicle accommodating the deflection or rebound of a motor vehicle wheel, and a rotation angle sensor connected to a control unit. The essentially circular grommets at the end of the connecting rods can be easily forced onto the essentially rotationally symmetrical bodies consisting of elastically deformable material.

### BRIEF DESCRIPTION OF THE DRAWINGS

Preferred and alternative examples of the present invention are described in detail below with reference to the following drawings:

FIG. 1 shows a perspective view of a known linkage;

FIG. 2 shows a side view of the linkage according to the invention;

FIG. 3 shows a top view, partially in section, of the linkage according to the invention;

FIG. 4 shows a perspective view of the linkage;

FIG. 5 shows a top view of a modified form of a linkage;

FIG. 6 shows a sectional view of the linkage shown in FIG. 5;

FIG. 7 shows a side view of the linkage shown in FIG. 5;

FIG. 8 shows a perspective view of the linkage shown in FIG. 5;

FIGS. 9 through 11 show different embodiments of the connecting rod used according to the invention. 5

### DETAILED DESCRIPTION OF THE PREFERRED EMBODIMENT

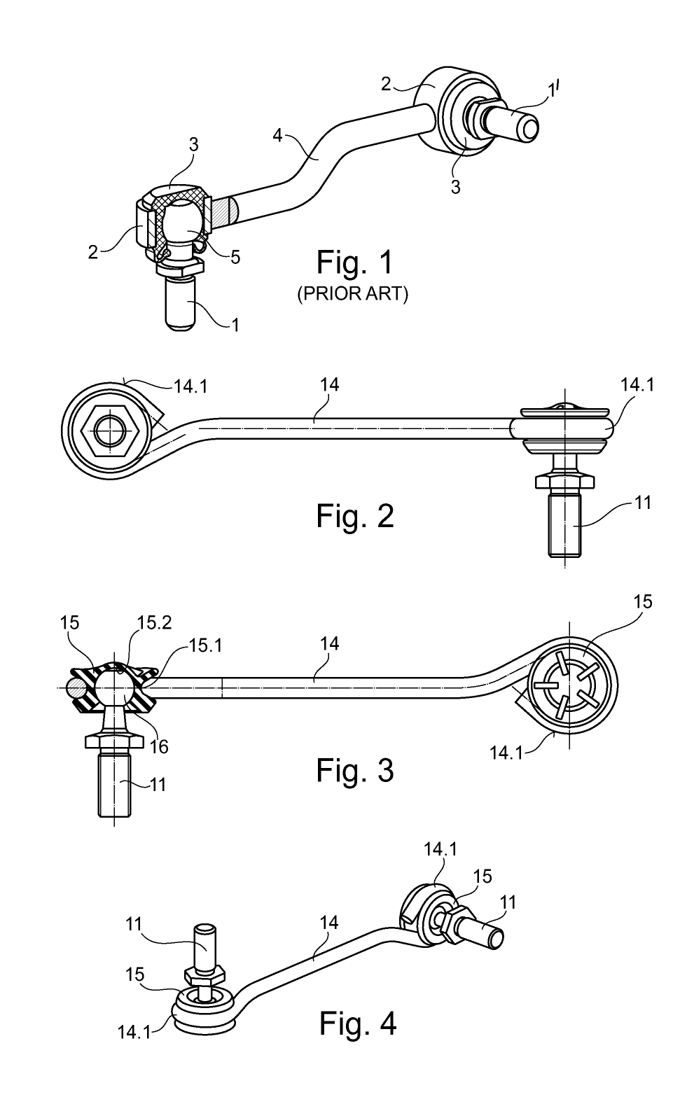

The linkage shown in FIG. 1 comprises an essentially cylindrical connecting rod 4, onto the ends of which are mounted ring-shaped ball socket brackets 2 of a ball socket 3, into each of which one ball 5 is inserted. Shafts 1 and 1′ are attached to these balls, of which shaft 1 serves, for example, for connecting a rotation angle sensor mounted in or on the chassis, whereas shaft 1′ serves for mounting in the area of the wheel suspension.

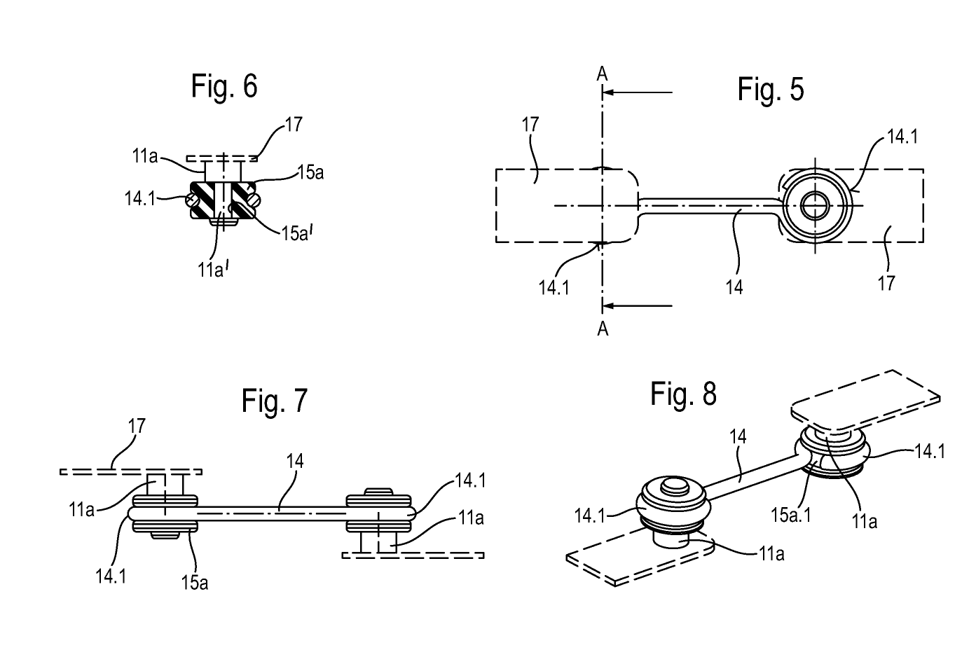

In the linkage according to the invention shown in FIGS. 2-5, the cylindrical connecting rod 14 is bent at its ends toward essentially circular grommets 14.1, which have been forced onto rotationally symmetrical bodies 15 of elastically deformable material. Each body 15 is provided with a circumferential groove 15.1 on its exterior, in each of which one grommet 14.1 has been rotatably accommodated. Each body 15 is provided with a recess forming a ball socket 15.2 into which a ball 16 is inserted rotatably, which supports a shaft 11 for mounting either on the wheel suspension or on the rotation angle sensor. The body 15 consists of elastically deformable material, preferably a silicone-like material.

Embodiments of a linkage shown in FIGS. 6 through 8 are distinguished from the embodiment according to FIGS. 2 through 5 in that the rotationally symmetrical body 15a consisting of elastically deformable material is provided with a drill hole running vertically for the bearing of the shaft 11a′ supporting the pin 11a. The body 15a is provided with a circumferential groove 15a.1 accommodating a grommet 14.1 on its outer circumference.

The pin 11a can be mounted, for example, by butt welding to a support 16 that typically represents either a wheel suspension or a rotation angle sensor.

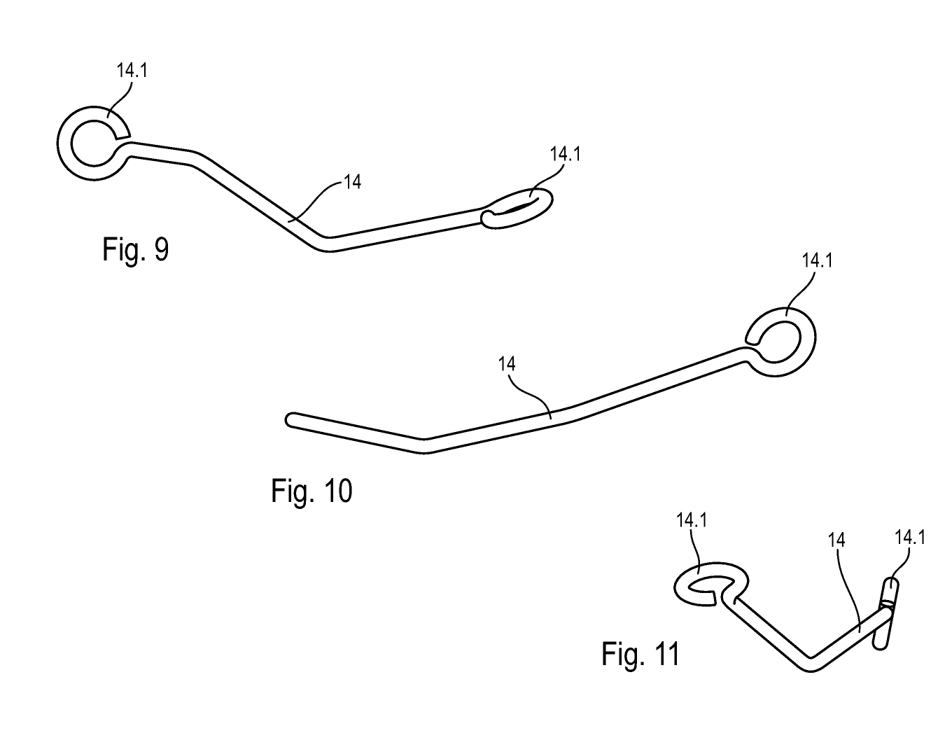

FIGS. 9 through 11 show examples of differently bent connecting rods 14 by means of which an easy adjustment into different positions is possible of the vehicle elements to be connected with each other by the linkage when producing the linkage according to the invention.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A linkage apparatus between a wheel suspension, mounted on the chassis of a motor vehicle accommodating the deflection or rebound of a motor vehicle wheel, and a rotation angle sensor connected to a control unit, comprising:
a connection rod having a first end and a second end;
a first shaft capable of swiveling mounted on the first end of the connection rod and connectable to the wheel suspension;
a second shaft capable of swiveling mounted on the second end of the connection rod and connectable to the rotation angle sensor; and
at least one rotationally symmetrical body of elastically deformable material supporting at least one of the first or second shafts;
wherein the connecting rod is bent on at least one of its ends toward an essentially circular grommet that has been forced onto the at least one rotationally symmetrical body of elastically deformable material supporting at least one of the first or second shafts.

2. The linkage apparatus according to claim 1, wherein the connecting rod has a cylindrical cross-section.

3. The linkage apparatus according to claim 1, wherein the at least one rotationally symmetrical body is provided with a circumferential groove on its exterior accommodating the grommet.

4. The linkage apparatus according to claim 1, wherein the at least one rotationally symmetrical body consists of silicone material.

5. The linkage according to claim 1, wherein the at least one rotationally symmetrical body has the shape of a ball socket casing into whose ball socket a ball supporting at least one of the first or second shafts is inserted.

6. The linkage according to claim 1, wherein the at least one rotationally symmetrical body has a drill hole running axially into which at least one of the first or second shafts is inserted.

7. The linkage apparatus according to claim 1, comprising:
a plurality of rotationally symmetrical bodies of elastically deformable materials, at least one each supporting the first and second shafts; and
wherein the connecting rod is bent on its first and second ends toward an essentially circular grommet that has been forced onto the rotationally symmetrical bodies of elastically deformable material supporting the first and second shafts, respectively.

8. The linkage apparatus according to claim 7, wherein the connecting rod has a cylindrical cross-section.

9. The linkage apparatus according to claim 7, wherein the plurality of rotationally symmetrical bodies are provided with a circumferential groove on their exterior accommodating the grommets.

10. The linkage apparatus according to claim 7, wherein the plurality of rotationally symmetrical bodies consist of silicone material.

11. The linkage according to claim 7, wherein the plurality of rotationally symmetrical bodies have the shape of a ball socket casing into whose ball socket a ball supporting the first or second shafts is inserted.

12. The linkage according to claim 7, wherein the plurality of rotationally symmetrical bodies have a drill hole running axially into which the first or second shafts are inserted.

13. A linkage system between a wheel suspension, mounted on the chassis of a motor vehicle accommodating the deflection or rebound of a motor vehicle wheel, and a rotation angle sensor connected to a control unit, comprising:
a connection rod having a first end and a second end;
a first shaft capable of swiveling mounted on the first end of the connection rod and connectable to the wheel suspension;
a second shaft capable of swiveling mounted on the second end of the connection rod and connectable to the rotation angle sensor; and
a plurality of rotationally symmetrical bodies of elastically deformable materials, at least one each supporting the first and second shafts; and
wherein the connecting rod is bent on its first and second ends toward an essentially circular grommet that has been forced onto the rotationally symmetrical bodies of elastically deformable material supporting the first and second shafts, respectively.

14. The linkage system according to claim 13, wherein the connecting rod has a cylindrical cross-section.

15. The linkage system according to claim 13, wherein the plurality of rotationally symmetrical bodies are provided with a circumferential groove on their exterior accommodating the grommets.

16. The linkage system according to claim 13, wherein the plurality of rotationally symmetrical bodies consist of silicone material.

17. The linkage system to claim 13, wherein the plurality of rotationally symmetrical bodies have the shape of a ball socket casing into whose ball socket a ball supporting the first or second shafts is inserted.

18. The linkage system to claim 13, wherein the plurality of rotationally symmetrical bodies have a drill hole running axially into which the first or second shafts are inserted.
